(19) United States
(12) Patent Application Publication
(10) Pub. No.: US 2002/0093815 A1
(43) Pub. Date: Jul. 18, 2002

(54) Light-projector

(76) Inventor: Yang-Wei Ou, Xiamen (CN)

Correspondence Address: Rosenberg,Klein & Lee, Suite 101, 3458 Ellicott Center Drive, Ellicott City, MD, 21043, US

(21) Appl. No.: 09/756,729

(22) Filed: Jan. 10, 2001

(51) Int. Cl. F21V 33/00

(52) U.S. Cl. 362/109; 362/800

(57) ABSTRACT

The present invention provides a light-projector comprising a metal trunk, a tube face, a light emitting diode, a button, a set of batteries and a back cover, wherein the metal trunk is a hollow tube with a side through hole for locating a button, and an insulating core seat located into the inside of the metal trunk has two through-holes without connecting each other for plugging in the long and short base pins of the light emitting diode therein the long pin stretches out from the core seat, and the short pin is hidden into the core seat, and for exposing the short pin, the core seat is cut through a groove so that a triangular spring leaf can cover on opposite the button exactly. Due to adopting above-mentioned mechanism, in the present invention the light emitting diode just need to plug into the plastic core seat without welding on a PC board, so the production cost is reduced and the procedures are decreased too.

### BACKGROUND OF THE INVENTION

1.Field of the Invention

The present invention relates to a light-projector, and more particularly to a light-projector applying a light emitting diode as light source.

2.Description of Prior Art

In accordance with the conventional light-projector using a light emitting diode as light source, said light emitting diode is welded on a PC board, therein a switcher is installed on for controlling the loop in or out, then the integrated PC board is mounted on a retaining bracket, and the tube face is made of metal. But the light-projector adopting this mechanism has following shortcomings:

1.Due to the higher production cost of the PC board, the procedures are complex, and the reject rate is easily increased;

2.Because the light emitting diode has to be welded on the PC board, the process steps are increased also;

3.As a result of the opacity of the metal tube face, it looks not enough beautiful.

### OBJECTS AND SUMMARY OF THE INVENTION

It is therefore a main object of the present invention to provide a light-projector with low cost, simple process and beautiful appearance.

This object is achieved by a light-projector comprising a metal trunk, a tube face, a light emitting diode, a button, a set of batteries and a back cover, wherein the metal trunk is a hollow tube with a side through hole for locating a button, and an insulating core seat located into the inside of the metal trunk has two through-holes without connecting each other for plugging in the long and short base pins of the light emitting diode therein the long pin stretches out from the core seat, and the short pin is hidden into the core seat, and for exposing the short pin, the core seat is cut through a groove so that a triangular spring leaf can cover on opposite the button exactly.

Said tube face is a transparent body.

Due to adopting above-mentioned mechanism, in the present invention the light emitting diode just need to plug into the plastic core seat without welding on a PC board, so the production cost is reduced and the procedures are decreased too. Meanwhile the triangular spring leaf replaces the switching device, the production cost is further reduced. Due to adopting the transparent tube face, the beautiful looking effect is became more special.

### BRIEF DESCRIPTION OF THE DRAWINGS

FIG. 1 is an exploded view of the present invention.

FIG. 2 is a cross-section view showing the core seat of the present invention.

FIG. 3 is a cross-section view showing the tube face in the second operation of the present invention.

FIG. 4 is a cross-section view showing the tube face in the third operation of the present invention.

FIG. 5 is a cross-section view showing the tube face in the fourth operation of the present invention.

FIG. 6 is a cross-section view showing the status before pressing the button;

FIG. 7 is a cross-section view showing the status after pressing the button.

### DETAILED DESCRIPTION OF PREFERRED EMBODIMENTS

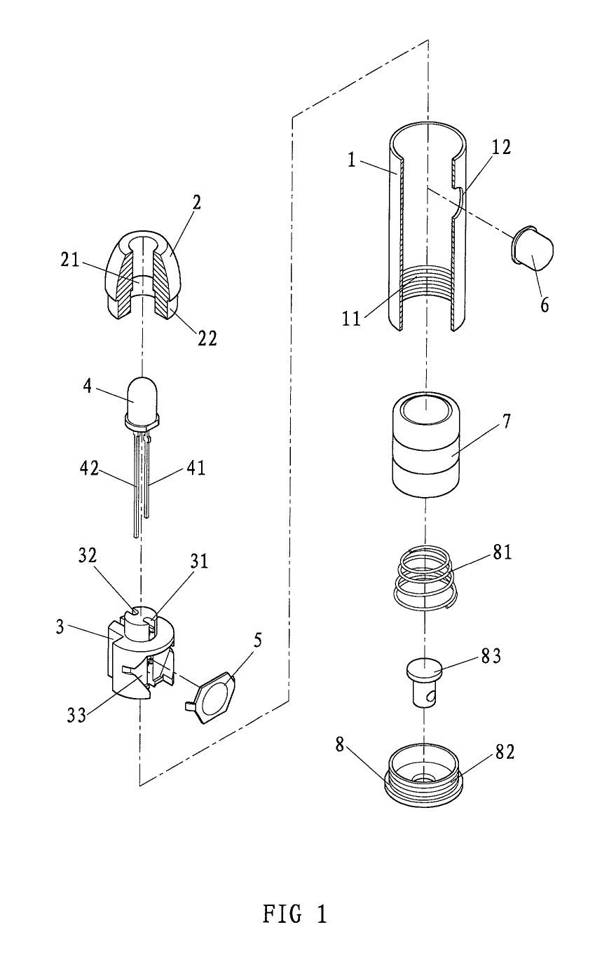

Referring to FIG. 1, the present invention includes a metal trunk 1, a tube face 2, a core seat 3, a light emitting diode 4, a triangular spring leaf 5, a button 6, a set of batteries 7 and a back cover 8.

Wherein, the metal trunk 1 is a hollow copper pipe holding the tube face 2 at one end and securing on the back cover 8 with an inner thread 11 at another end, and a small through-hole 12 is drilled on a proper position of the side wall for locating the button 6.

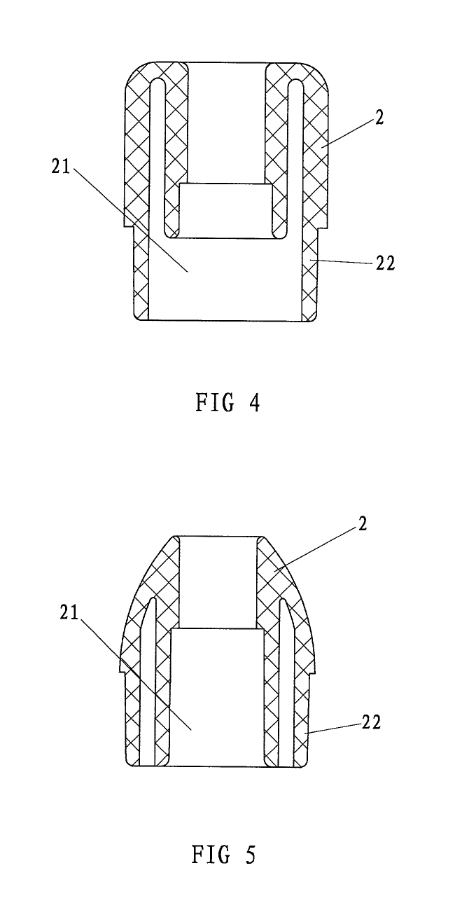

The tube face 2 is made of transparent plastic, therein there is a cabinet 21 for holding the light emitting diode 4, and a back portion 2 may fit into the one end of the metal trunk 7 in tight fit. The tube face 2 can be shaped in other styles, as showing in FIG. 3, FIG. 4 and FIG. 5.

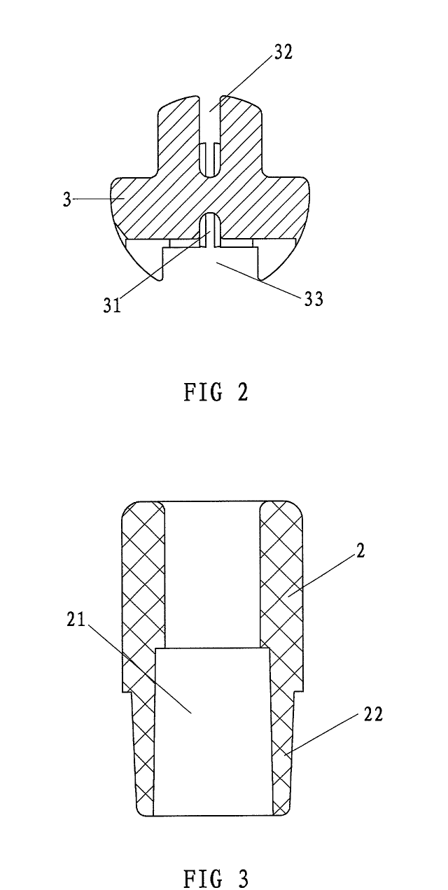

The core seat 3 is made of insulating material, therein two disconnecting strip slots 31 and 32 are cut through for plugging in the both base pins of the light emitting diode 4, and a groove 33 is cut through on a proper position of the outside wall so that a base pin can be exposed through the groove 33 and is covered with the triangular spring leaf 5 opposite the button 6, as showing on FIG. 2. Said strip slots can be designed into through-holes.

The back cover 8 is welded with a spreader spring 81, and cut through a outer thread 82 for securing on the metal trunk 1, and put on a bail 83 at back end.

The light emitting diode 4 has two base pins 41, 12 one longer and another shorter, as plugging into the strip slots 31, 32 of the core seat 3, just the long pin 41 stretches out from the bottom of the core seat 3 to contact with battery 7, and the short pin 42 hiding into the core seat 3 is exposed into the groove 33 and covered with a triangle spring leaf 5.

In combining, first locate the tube face 2 on the metal trunk 1, then sequentially put in the assembled core seat 3, the triangular spring leaf 5, the button 6 and the batteries 7, finally secure the back cover 8 on the back end of the metal trunk 1.

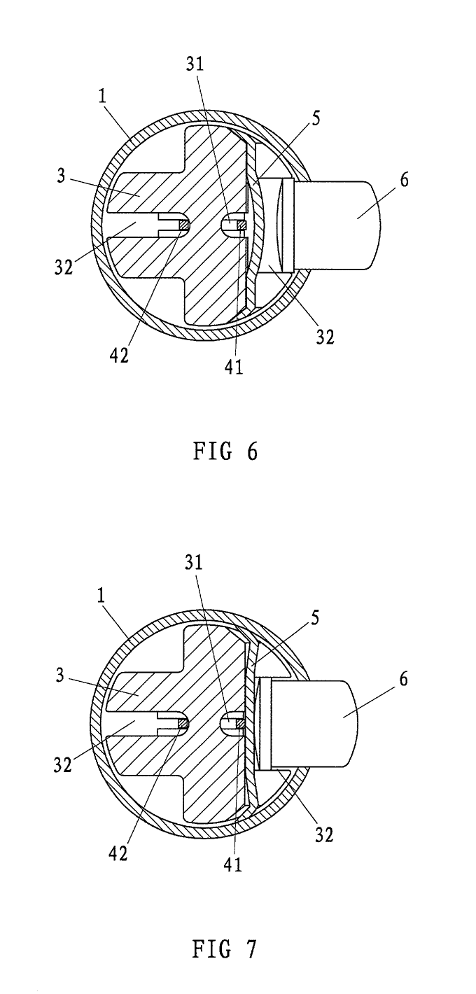

Refer to FIG. 6 and 7, as using, press the button 6 downward to make the triangular spring leaf 5 deformation and touch against the metal trunk 1 and the short pin 42 of the light emitting diode 4 so as to lead the loop, the light-projector shoots out the light.

I claim:

1. A light-projector comprising a metal trunk, a tube face, a light emitting diode, a button, a set of batteries and a back cover, wherein the metal trunk is a hollow tube with a side through hole for locating a button, and an insulating core seat located into the inside of the metal trunk has two through-holes without connecting each other for plugging in the long and short base pins of the light emitting diode therein the long pin stretches out from the core seat, and the short pin is hidden into the core seat, and for exposing the short pin, the core seat is cut through a groove so that a triangular spring leaf can cover on opposite the button exactly.

2. A light-projector as claimed in claim 1, wherein the tube face is a transparent body.
